(19) United States
(12) Patent Application Publication
(10) Pub. No.: US 2026/0134594 A1
(43) Pub. Date: May 14, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Gaku NAKANO, Tokyo (JP)

(73) Assignee: NEC Corporation, Tokyo (JP)

(21) Appl. No.: 19/359,962

(22) Filed: Oct. 16, 2025

(30) Foreign Application Priority Data
Nov. 14, 2024 (JP) 2024-199021

(51) Int. Cl. G06T 11/60; G06T 7/13; G06V 10/77

(52) U.S. Cl. CPC G06T 11/60; G06T 7/13; G06V 10/7715

(57) ABSTRACT

An information processing apparatus includes a related point detection unit that extracts feature points having scale and angle information from two images each obtained by imaging the same object from different directions, and detects a pair of the feature points related between the images from the feature points extracted from each image, a related line detection unit that detects, for each pair of the feature points, a pair of lines related between the images using a position and the angle information of each feature point, a related region detection unit that detects, for each pair of the feature points, a pair of regions related between the images using the position and the scale information of each feature point, and a transformation matrix generation unit that generates a homography matrix for transforming one of the images into the other using the pair of related lines and the pair of related regions.

This application is based upon and claims the benefit of priority from Japanese patent application No. 2024-199021, filed on Nov. 14, 2024, the disclosure of which is incorporated herein in its entirety by reference.

### TECHNICAL FIELD

The present disclosure relates to a technology for generating a homography matrix.

### BACKGROUND ART

Transformation for connecting images in a plurality of images obtained by imaging a certain plane from different angles is referred to as a homography. The homography is represented by a 3×3 matrix, and is transformation that makes a certain quadrangle into another quadrangle. Therefore, it is known that a homography matrix can be generated when four different points on the plane can be observed on the images. JP 7334058 B2 discloses a technology for detecting equal to or more than four pairs of related feature points (hereinafter, simply referred to as related points) from between two images, and applying a direct linear transform (DLT) method to the detected related point pairs to convert a bird's eye view image of a sports scene into a frontal view.

D. Barath, Z. Kukkelova, “Homography from two orientation- and scale-covariant features”, 2019 IEEE/CVF International Conference on Computer Vision (ICCV), pp. 1091-1099, 2019 (Hereinafter referred to as “D. Barath et. al.”) and JP 7448034 B2 disclose technologies for generating a homography matrix by equal to or more than two related point pairs by using feature points for calculating a scale and an angle in addition to image coordinates. Such feature points are extracted by calculating a scale invariant feature transform (SIFT) feature value or a speeded-up robust features (SURF) feature value from an image.

According to the technologies disclosed in D. Barath et. al and JP 7448034 B2, as compared with the technology disclosed in JP 7334058 B2, the minimum number of pairs of the related point pairs used for the generation can be reduced from four to two, and thus an effect of reducing the number of trials in combination optimization such as random sample consensus (RANSAC) is expected.

### SUMMARY

However, the homography matrix generation methods each using the two related point pairs disclosed in D. Barath et. al and JP 7448034 B2 have the following problems. The problems will be specifically described below.

First, the method disclosed in D. Barath et. al uses, as a constraint condition, the fact that invariance between the scale and the angle of the feature point is associated by affine transformation that is a primary approximation of a homography. However, at the feature point such as the SIFT or the SURF, variable elimination is performed by setting a skew value of the affine transformation that should be zero as non-zero. Therefore, the method disclosed in D. Barath et. al has a problem that numerical operation is unstable.

The method disclosed in JP 7448034 B2 generates an additional related point pair from the scale and the angle of the feature point to generate the homography matrix. However, a scale value of the feature point such as the SIFT or the SURF is generally about several pixels to 10 pixels, and is relatively very small compared to a distance between the feature points, which is several tens of pixels to several hundreds of pixels. Therefore, a quadrangle defined by using detected two related point pairs and added two related point pairs has an elongated linear shape, which is close to a so-called degeneracy condition. As a result, the method disclosed in JP 7448034 B2 also has the problem that numerical operation is unstable.

An example of an object of the present disclosure is to suppress instability of numerical operation in generation of a homography matrix using two related point pairs.

In order to achieve the above object, an information processing apparatus in one aspect of the present disclosure includes
a related point detection unit that extracts feature points having scale information and angle information from each of two images obtained by imaging the same object from different directions, and detects a pair of the feature points related between the images from among the feature points extracted from the two images,
a related line detection unit that detects, for each pair of the feature points, a pair of lines related between the images by using a position and the angle information of each feature point constituting the pair,
a related region detection unit that detects, for each pair of the feature points, a pair of regions related between the images by using the position and the scale information of each feature point constituting the pair, and
a transformation matrix generation unit that generates a homography matrix for transforming one of the images into the other by using the pair of lines related between the images and the pair of regions related between the images.

In order to achieve the above object, an information processing method in one aspect of the present disclosure includes
a related point detection step of extracting feature points having scale information and angle information from each of two images obtained by imaging the same object from different directions, and detecting a pair of the feature points related between the images from among the feature points extracted from the two images,
a related line detection step of detecting, for each pair of the feature points, a pair of lines related between the images by using a position and the angle information of each feature point constituting the pair,
a related region detection step of detecting, for each pair of the feature points, a pair of regions related between the images by using the position and the scale information of each feature point constituting the pair, and
a transformation matrix generation step of generating a homography matrix for transforming one of the images into the other by using the pair of lines related between the images and the pair of regions related between the images.

In order to achieve the above object, a computer-readable recording medium in one aspect of the present disclosure records a program including a command for causing
a computer to execute
a related point detection step of extracting feature points having scale information and angle information from each of two images obtained by imaging the same object from different directions, and detecting a pair of the feature points related between the images from among the feature points extracted from the two images,
a related line detection step of detecting, for each pair of the feature points, a pair of lines related between the images by using a position and the angle information of each feature point constituting the pair,
a related region detection step of detecting, for each pair of the feature points, a pair of regions related between the images by using the position and the scale information of each feature point constituting the pair, and
a transformation matrix generation step of generating a homography matrix for transforming one of the images into the other by using the pair of lines related between the images and the pair of regions related between the images.

As described above, according to the present disclosure, it is possible to suppress instability of numerical operation in generation of a homography matrix using two related point pairs.

### BRIEF DESCRIPTION OF THE DRAWINGS

FIG. 1 is a diagram illustrating an example of a pair of feature points related between images;

FIG. 2 is a configuration diagram illustrating a schematic configuration of an example of an information processing apparatus;

FIG. 3 is a configuration diagram specifically illustrating a configuration of an example of the information processing apparatus;

FIG. 4 is a flowchart illustrating an example of operation of the information processing apparatus; and

FIG. 5 is a block diagram illustrating an example of a computer that achieves the information processing apparatus.

### EXAMPLE EMBODIMENT

### (Premise Description)

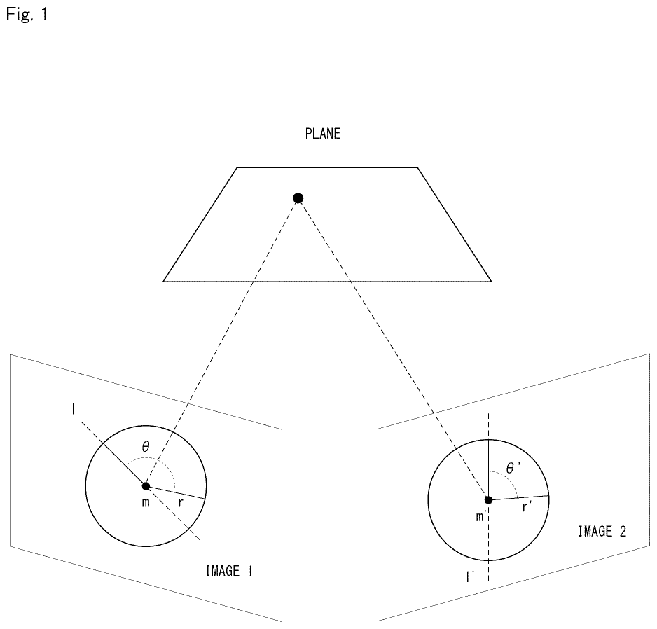

First, matters that serve as a premise of the present disclosure will be described with reference to FIG. 1. FIG. 1 is a diagram illustrating an example of a pair of feature points related between images. In the example of FIG. 1, an image 1 and an image 2 are obtained by imaging the same object from different directions.

Specifically, as illustrated in FIG. 1, a certain point on a plane is imaged from different angles. As a result, a feature point m in the image 1 and a feature point m′ in the image 2 are observed. The feature point m and the feature point m′ constitute a related point pair obtained by observing the point on the same plane on the different images. Hereinafter, the pair of feature points related to each other is also referred to as the “related point pair”.

Such feature points are extracted by calculating, from image data of the images, a scale invariant feature transform (SIFT) feature value or a speeded-up robust features (SURF) feature value, for example. Such feature points extracted from the feature value have scale information and angle information.

The scale information indicates a region in which the feature value is within a set range with the feature point as a center. In the example of FIG. 1, the scale information is indicated by a circle having a radius r centered on the feature point. The angle information indicates a direction of the feature point obtained from a gradient direction histogram of luminance in the region centered on the feature point. In the example of FIG. 1, it is indicated by θ.

As illustrated in FIG. 1, the feature point m has a scale r and an angle θ as the scale information and the angle information. The feature point m′ related to the feature point m has a scale r′ and an angle θ′ as the scale information and the angle information. A line l in the image 1 is a straight line having an inclination θ passing through the feature point m. Similarly, a line l′ in the image 2 is a straight line having an inclination θ′ passing through the feature point m′.

### Example Embodiment

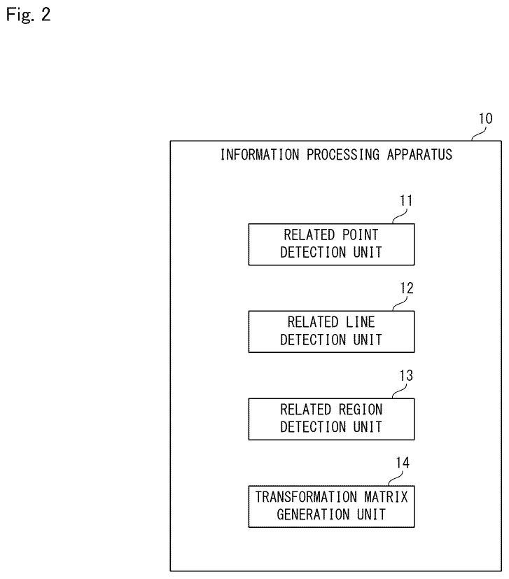

Hereinafter, an information processing apparatus, an information processing method, and a program in an example embodiment will be described with reference to FIGS. 2 to 5.

[Apparatus Configuration]

First, a schematic configuration of the information processing apparatus will be described with reference to FIG. 1. FIG. 2 is a configuration diagram illustrating the schematic configuration of an example of the information processing apparatus.

An information processing apparatus 10 illustrated in FIG. 2 is an apparatus for generating a homography matrix between images, in other words, a homography matrix generation apparatus. As illustrated in FIG. 2, the information processing apparatus includes a related point detection unit 11, a related line detection unit 12, a related region detection unit 13, and a transformation matrix generation unit 14.

The related point detection unit 11 extracts feature points having scale information and angle information from each of two images obtained by imaging the same object from different directions. The related point detection unit 11 then detects a pair of related feature points (related point pair) between the images from among the feature points extracted from the two images.

The related line detection unit 12 detects, for each related point pair, a pair of related lines (hereinafter, referred to as “related line pair”) between the images by using a position and angle information of each feature point constituting the related point pair.

The related region detection unit 13 detects, for each related point pair, a pair of related regions (hereinafter, referred to as “related region pair”) between the images by using a position and scale information of each feature point constituting the related point pair.

The transformation matrix generation unit 14 generates, by using the related line pairs and the related region pairs, a homography matrix for transforming one of the images to the other.

In this manner, the information processing apparatus 10 generates the homography matrix by using not only the related point pairs but also the related line pairs and the related region pairs detected from the feature points constituting the related point pairs.

Therefore, according to the information processing apparatus 10, it is possible to suppress instability of numerical operation in the generation of the homography matrix using the two related point pairs.

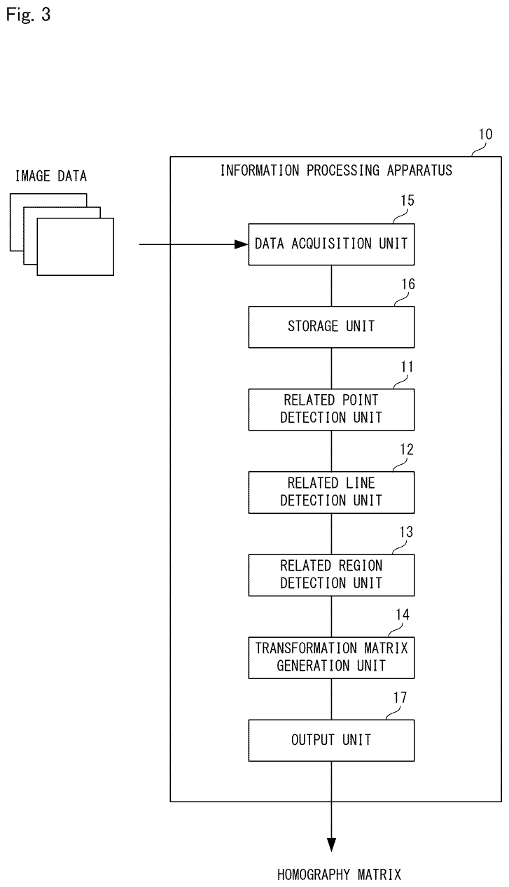

Subsequently, the configuration and the function of the information processing apparatus 10 will be more specifically described with reference to FIG. 3. FIG. 3 is a configuration diagram specifically illustrating the configuration of an example of the information processing apparatus.

As illustrated in FIG. 3, the information processing apparatus 10 includes a data acquisition unit 15, a storage unit 16, and an output unit 17 in addition to the related point detection unit 11, the related line detection unit 12, the related region detection unit 13, and the transformation matrix generation unit 14 described above.

The data acquisition unit 15 acquires, from an external device, for example, a server device, a terminal device, or an imaging device, image data of the images obtained by imaging the same object from the different directions, and stores the acquired image data in the storage unit 16.

In the example embodiment, the related point detection unit 11 first extracts image data of two images (an image 1 and an image 2) from the storage unit 16, and extracts feature points from each image of the two pieces of extracted image data. Specifically, the related point detection unit 11 extracts the feature points by calculating, for example, a scale invariant feature transform (SIFT) feature value or a speeded-up robust features (SURF) feature value in each image.

The related point detection unit 11 then detects equal to or more than two related point pairs by applying an existing feature point matching technology to the extracted feature points. As described above, each of the extracted feature points has the scale information indicated by a radius r and the angle information indicated by an angle θ.

In the example embodiment, the related line detection unit 12 specifies a virtual line passing through each feature point by using a position and the angle information of each feature point constituting the related point pair for each related point pair, and detects the specified virtual lines of the feature points as the related line pair. Specifically, when it is assumed that the related point pair includes a feature point mᵢ and a feature point m′ᵢ, as illustrated in FIG. 1, the related line detection unit 12 specifies a line lᵢ that is a straight line passing through the feature point mᵢ and having an inclination θi, specifies a line l′ᵢ that is a straight line passing through the feature point m′ᵢ and having an inclination θ′ᵢ, and sets the specified line lᵢ and line l′ᵢ as the related line pair.

In the example embodiment, the related region detection unit 13 specifies, for each related point pair, a virtual circle centered on each feature point by using the position and the scale information of each feature point constituting the related point pair, and detects regions surrounded by the virtual circles as the related region pair.

Specifically, when it is assumed that the related point pair includes the feature point mᵢ and the feature point m′ᵢ, as illustrated in FIG. 1, the related region detection unit 13 specifies a region surrounded by a circle having a radius rᵢ centered on the feature point mᵢ, specifies a region surrounded by a circle having a radius r′ᵢ centered on the feature point m′ᵢ, and sets the specified two circular regions as the related region pair.

In the example embodiment, the transformation matrix generation unit 14 generates the homography matrix by using the related line pairs and the related region pairs detected for each of the equal to or more than two detected related point pairs.

The output unit 17 outputs the homography matrix generated by the transformation matrix generation unit 14. Examples of an output destination include an image processing apparatus. The information processing apparatus 10 may constitute a part of the image processing apparatus. Examples of the image processing apparatus include an apparatus that generates three-dimensional data of an object from a plurality of images of the object by using a homography matrix.

### [Apparatus Operation]

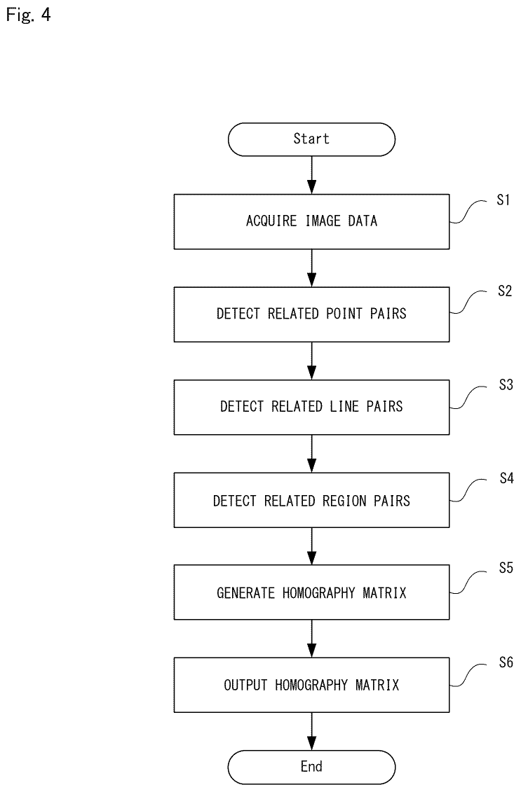

Next, operation of the information processing apparatus 10 will be described with reference to FIG. 4. FIG. 4 is a flowchart illustrating an example of the operation of the information processing apparatus. FIGS. 1 to 3 will be appropriately referred to in the following description. In the example embodiment, the information processing method is performed by operating the information processing apparatus 10. Therefore, description of the information processing method in the example embodiment is substituted with the following description of the operation of the information processing apparatus 10.

As illustrated in FIG. 4, first, the data acquisition unit 15 acquires, from an external device, image data of images obtained by imaging the same object from different directions (step S1). The data acquisition unit 15 stores each piece of the acquired image data in the storage unit 16.

Next, the related point detection unit 11 acquires image data of optional two images (the image 1 and the image 2) from the storage unit 16, executes feature point matching on each image of the acquired image data, and detects equal to or more than two related point pairs (step S2).

Next, for each related point pair detected in step S2, the related line detection unit 12 detects a related line pair by using a position and angle information of each feature point constituting the related point pair (step S3).

Specifically, in step S3, the related line detection unit 12 specifies, for each related point pair, a virtual line passing through each feature point by using the position and the angle information of each feature point constituting the related point pair, and detects the specified virtual lines of the feature points as the related line pair.

Next, for each related point pair detected in step S2, the related region detection unit 13 detects a related region pair by using the position and scale information of each feature point constituting the related point pair (step S4).

Specifically, in step S4, the related region detection unit 13 specifies, for each related point pair, a virtual circle centered on each feature point by using the position and the scale information of each feature point constituting the related point pair, and detects regions surrounded by the virtual circles as the related region pair.

Next, the transformation matrix generation unit 14 generates a homography matrix by using the related line pairs detected in step S3 and the related region pairs detected in step S4 (step S5).

Thereafter, the output unit 17 outputs the homography matrix generated in step S5 (step S6).

In a case where it is needed to generate a homography matrix also between another two images, steps S2 to S6 are executed again. In this case, in step S2, the related point detection unit 11 acquires image data for a different combination of two images.

It is assumed that equal to or more than three related point pairs are detected in step S2, and as a result, equal to or more than three related line pairs and related region pairs are also detected. In this case, in step S5, the transformation matrix generation unit 14 can execute the generation of the homography matrix a plurality of times while changing the related line pair and the related region pair to be used. The transformation matrix generation unit 14 then executes evaluation of accuracy for the plurality of generated homography matrices, and selects a homography matrix with the highest accuracy based on evaluation results.

Examples of a method of selecting a highly accurate homography matrix include, as performed in the RANSAC, a method of applying the generated homography matrices to related point pairs that have not been used for the generation, measuring reprojection errors between related points, and selecting a homography matrix that minimizes a total value of the measured reprojection errors. In this method, instead of the reprojection error, a Sampson error, an algebraic error, or the like, which is a primary approximation of the reprojection error, may be used.

### Specific Example

Here, a specific example of processing in the information processing apparatus 10 will be described below. In the following specific example, coordinates of the feature point are represented by 3×1 homogeneous representation. For example, coordinates of a feature point m and a related feature point m′ are represented by m=[u, v, l]^{T} and m′=[u′, v′, l]^{T}. The homography matrix is represented by a 3×3 matrix H. The number of elements of the matrix H is 9, but since there is scale uncertainty, a degree of freedom is 8.

Specifically, a homography of the feature point m and the feature point m′ as the related point pair is represented by the following Expression 1. In the following Expression 1, “˜” represents that both sides are equal to a constant multiple.

$${m}^{′} ∼ Hm \qquad [ Expression 1 ]$$

Next, the related line pair will be described. As described above, the feature point m has the angle θ as the angle information. Therefore, a straight line l passing through the feature point m is represented by the following Expression 2.

$${l}^{T} m = 0 \qquad [ Expression 2 ]$$

$$l = {[ sin θ , - cos θ , v cos θ - u sin θ ]}^{T}$$

With the above Expression 1 and the above Expression 2, a homography of the line l and a related line l′ is represented by the following Expression 3.

$${l}^{T} H = {l}^{T} {H}^{- 1} Hm = {l}^{′ T} {m}^{′} = 0 \qquad [ Expression 3 ]$$

$$↔ {l}^{′} ∼ {H}^{- T} l$$

$$↔ l ∼ {H}^{T} {l}^{′}$$

Next, the related region pair will be described. Here, it is assumed that the related region is a circle. In the image 1, a circle C having center coordinates of (cᵤ, cᵥ) and a radius of r is represented by the following Expression 4 in a quadratic form. In the following Expression 4, a point x is an optional point on the circle C.

$${x}^{T} Cx = 0 \qquad [ Expression 4 ]$$

$$C = [ \begin{matrix}1 & 0 & - {c}_{u} \\ 0 & 1 & - {c}_{v} \\ - {c}_{u} & - {c}_{v} & {c}_{u}^{2} + {c}_{v}^{2} - {r}^{2}\end{matrix} ]$$

Since x′˜ Hx is obtained when the point x is subjected to a homography to a point x′ by the matrix H, the circle C is projected to a circle C′ as indicated in the following Expression 5.

$${x}^{T} Cx = {x}^{T} {H}^{T} {H}^{- T} {CH}^{- 1} Hx = {x}^{′ T} {Hx}^{′} = 0 \qquad [ Expression 5 ]$$

$${C}^{′} ∼ {H}^{- T} {CH}^{- 1}$$

$$↔ C ∼ {H}^{T} {C}^{′} H$$

Next, when a plurality of circles is present on the same plane and circles Cᵢ and Cⱼ relate to circles C′ᵢ and C′ⱼ, a relationship of the following Expression 6 is obtained.

$${C}_{i}^{- 1} {C}_{j} ∼ {H}^{- 1} {C}_{i}^{′ - 1} {C}_{j}^{′} H \qquad [ Expression 6 ]$$

$$↔ {HC}_{i}^{- 1} {C}_{j} - {C}_{i}^{′ - 1} {C}_{j}^{′} H = 0$$

Here, since quadratic form representation of the circle has scale uncertainty, determinants are normalized to be equal to each other as indicated in the following Expression 7.

$$det ( {C}_{i} ) = det ( {C}_{j} ) , det ( {C}_{i}^{′} ) = det ( {C}_{j}^{′} ) \qquad [ Expression 7 ]$$

Therefore, when N related point pairs are given from the above Expression 3 and Expression 6, it is possible to estimate the matrix H by solving an optimization problem represented by the following Expression 8. In the following Expression 8, “x” represents a cross product of three-dimensional vectors.

$${min}_{H} {\sum }_{i = 1}^{N} {‖ {l}_{i} \times {H}^{T} {l}_{i}^{′} ‖}^{2} + {\sum }_{i , j = 1 , i \neq j}^{N} {‖ {HC}_{i}^{- 1} {C}_{j} - {C}_{i}^{′ - 1} {C}_{j}^{′} H ‖}^{2} \qquad [ Expression 8 ]$$

$$s . t . {‖ H ‖}^{2} = 1$$

Here, steps S2 to S5 illustrated in FIG. 4 will be described in detail for each step along the above specific example.

### [Step S2]

In step S2, the related point detection unit 11 acquires the image data of the image 1 and the image data of the image 2. The related point detection unit 11 then executes the feature point matching on the image 1 and the image 2 to detect the N related point pairs {mᵢ, m′ᵢ; i∈{1, . . . , N}, N≥2}. The subscript “i” indicates a related number.

### [Step S3]

In step S3, the related line detection unit 12 calculates the line 1; passing through the feature point mᵢ and the line l′ᵢ passing through the feature point m′ᵢ based on the above Expression 2 for each of mᵢ and m′ᵢ of the related point pair, and detects N related line pairs {lᵢ, l′ᵢ; i∈{1, . . . , N}, N≥2}.

### [Step S4]

In step S4, the related region detection unit 13 detects, for each of mᵢ and m′ᵢ of the related point pair, N related circle pairs {Cᵢ, C′ᵢ; i∈{1, . . . , N}, N≥2} including the circle Cᵢ having center coordinates as the feature point mᵢ and a radius as a scale rᵢ of the feature point mᵢ and the circle C′ᵢ having center coordinates as the feature point m′ᵢ and a radius as a scale r′ᵢ of the feature point m′ᵢ, based on the above Expression 6.

### [Step S5]

In step S5, the transformation matrix generation unit 14 generates the homography matrix based on the above Expression 8 by using the detected N (N≥2) related line pairs and related circle pairs.

### Effects of Example Embodiment

As described above, according to the example embodiment, the instability of the numerical operation is suppressed, and the homography matrix can be generated when there are at least two related point pairs by the scale information and the angle information included in the feature point. The reason is as follows.

As illustrated in FIG. 1, one related line pair is defined for one related point pair. Since the related line l always passes through the feature point m, one constraint condition is obtained from one related line pair [lᵢ×H^{T}l′ᵢ]. Six constraint conditions are further obtained from two related region pairs [{Cᵢ, Cⱼ}⇔{C′ᵢ, C′ⱼ}] indicated in the above Expression 6.

The number of combinations for selecting two pairs from the N related region pairs without duplication is _{N}C₂=N×(N−1)/2. The number of constraints obtained from the N related line pairs and the N related region pairs is larger than the degree of freedom of 8 of the matrix H when N+6×N×(N−1)/2≥8 is satisfied. That is, when there are at least N=2 related point pairs, the above Expression 8 can be solved, and thus the matrix H can be generated.

Since the above Expression 8 is a linear equation for the matrix H, it can result in the well-known DLT method. There is no need to consider the homography (the above Expression 1) of the position coordinates of the related point pair. This is because the center coordinates, that is, the coordinate position of the feature point is included in the circle represented in the quadratic form, as indicated in the above Expression 4.

According to the example embodiment, the generation accuracy of the homography matrix can be made higher than that of the method disclosed in JP 7448034 B2. This is because the feature point on the related region is not explicitly used as an additional related point. As indicated by the above Expression 6, the constraint of the related region based on the scale of the feature point is represented by a ratio of two circles such as Cᵢ⁻¹Cⱼ. Therefore, since deformation of a thin linear quadrangle is not premised, stability of the numerical operation is improved.

### Modification

The example embodiment described above is not limited to the examples described above. Various changes understandable by so-called those of ordinary skill in the art can be applied to the example described above. For example, the first and second example embodiments can also be performed by modes illustrated in the following modifications.

For example, in the example embodiment, in a case where a related point pair includes an error (a misrelated point or an outlier), the misrelated point may be removed by using the RANSAC disclosed in JP 7448034 B2 and LO-RANSAC that is a derivative of the RANSAC. Since the RANSAC is a widely known technology, detailed description of the RANSAC will be omitted.

In random sampling of two related point pairs, signs of a normal line formed by a vector connecting feature points of a related point pair and a related line pair may be compared to determine a misrelated point. Here, the “signs of a normal line formed by a vector connecting feature points of a related point pair and a related line pair” will be described.

It is assumed that the two related point pairs are {m₁, m₂}⇔{m′₁, m′₂}, and the two related line pairs are {l₁, l₂}⇔{l′₁, l′₂}]. The vector connecting the feature points of the related point pair is a vector connecting coordinates of the feature points. Therefore, examples of the signs of the normal line formed by the vector connecting the feature points of the related point pair and the related line pair include a sign of a determinant of a 3×3 matrix [m₁, m₂, l₁] and a sign of a determinant of a 3×3 matrix [m′₁, m′₂, l′₁].

As widely known in estimation of a homography matrix, the fact that the signs of the determinants are the same is a necessary condition that the related point pair and the related line pair are correct. Therefore, the misrelated point can be determined by comparing the signs of the determinants. In addition to the matrices described above, a sign of a determinant of [m₁, m₂, l₂] and a sign of a determinant of [m′₁, m′₂, l′₂] may be used. By adding the signs of the determinants, a determination criterion becomes more strict, and a probability of being the correct related point pair and related line pair increases.

### [Program]

In the example embodiment, the program may be any program that causes a computer to execute steps S1 to S6 illustrated in FIG. 4. When the program is installed and executed in the computer, the information processing apparatus 10 and the information processing method can be achieved. In this case, a processor of the computer functions as the related point detection unit 11, the related line detection unit 12, the related region detection unit 13, the transformation matrix generation unit 14, the data acquisition unit 15, and the output unit 17, and performs processing.

The storage unit 16 may be achieved by a storage device such as a hard disk provided in the computer, or may be achieved by a storage device of another computer. Examples of the computer include a smartphone and a tablet terminal device in addition to a general-purpose PC and a server computer.

In the example embodiment, the program may be executed by a computer system (such as a cloud system) constructed by a plurality of computers. In this case, for example, each computer may function as any one of the related point detection unit 11, the related line detection unit 12, the related region detection unit 13, the transformation matrix generation unit 14, the data acquisition unit 15, and the output unit 17.

### [Physical Configuration]

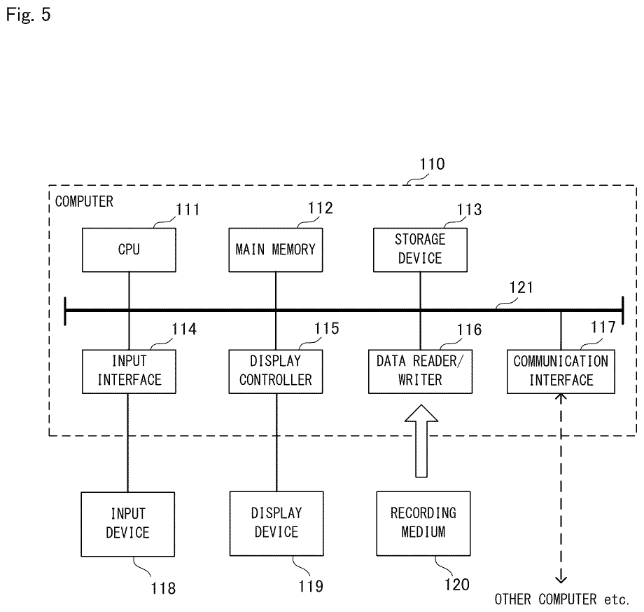

Here, the computer that achieves the information processing apparatus 10 by executing the program in the example embodiment will be described with reference to FIG. 5. FIG. 5 is a block diagram illustrating an example of the computer that achieves the information processing apparatus.

As illustrated in FIG. 5, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA may execute the program in the example embodiment.

The CPU 111 loads the program in the example embodiment, which is stored in the storage device 113 and includes codes, into the main memory 112, and executes each code in predetermined order to perform various operations. The main memory 112 is typically a volatile storage device such as a dynamic random access memory (DRAM).

The program in the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result of the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) and a secure digital (SD), a magnetic recording medium such as a flexible disk, and an optical recording medium such as a compact disk read only memory (CD-ROM).

The information processing apparatus 10 can also be achieved by using hardware related to each unit, for example, an electronic circuit, instead of the computer in which the program is installed. A part of the information processing apparatus 10 may be achieved by a program, and the remaining part may be achieved by hardware. In the example embodiment, the computer is not limited to the computer illustrated in FIG. 5.

Some or all of the example embodiments described above can be represented by (Supplementary Note 1) to (Supplementary Note 15) described below, but are not limited to the following description.

### Supplementary Note 1

An information processing apparatus including:
a related point detection unit that extracts feature points having scale information and angle information from each of two images obtained by imaging the same object from different directions, and detects a pair of the feature points related between the images from among the feature points extracted from the two images;
a related line detection unit that detects, for each pair of the feature points, a pair of lines related between the images by using a position and the angle information of each feature point constituting the pair;
a related region detection unit that detects, for each pair of the feature points, a pair of regions related between the images by using the position and the scale information of each feature point constituting the pair; and
a transformation matrix generation unit that generates a homography matrix for transforming one of the images into the other by using the pair of lines related between the images and the pair of regions related between the images.

### Supplementary Note 2

The information processing apparatus according to Supplementary Note 1, in which
the related line detection unit specifies, for each pair of the feature points, a virtual line passing through each feature point by using the position and the angle information of each feature point constituting the pair, and detects the specified virtual lines of the feature points as the pair of lines related between the images.

### Supplementary Note 3

The information processing apparatus according to Supplementary Note 1, in which
the related region detection unit specifies, for each pair of the feature points, a virtual circle centered on each feature point by using the position and the scale information of each feature point constituting the pair, and detects regions surrounded by the specified virtual circles of the feature points as the pair of regions related between the images.

### Supplementary Note 4

The information processing apparatus according to Supplementary Note 1, in which
the transformation matrix generation unit executes the generation of the homography matrix a plurality of times while changing the pair of lines related between the images and the pair of regions related between the images, and selects one of a plurality of the generated homography matrices.

### Supplementary Note 5

The information processing apparatus according to Supplementary Note 1, in which
the transformation matrix generation unit selects a specific pair of the feature points and a pair of lines related between the images detected from the specific pair of feature points, calculates a vector connecting one feature point and the other feature point in the selected pair of feature points, calculates a normal line formed by the calculated vector and the selected pair of lines, and determines whether to generate the homography matrix based on a sign of a component of the calculated normal line.

### Supplementary Note 6

An information processing method including:
a related point detection step of extracting feature points having scale information and angle information from each of two images obtained by imaging the same object from different directions, and detecting a pair of the feature points related between the images from among the feature points extracted from the two images;
a related line detection step of detecting, for each pair of the feature points, a pair of lines related between the images by using a position and the angle information of each feature point constituting the pair;
a related region detection step of detecting, for each pair of the feature points, a pair of regions related between the images by using the position and the scale information of each feature point constituting the pair; and
a transformation matrix generation step of generating a homography matrix for transforming one of the images into the other by using the pair of lines related between the images and the pair of regions related between the images.

### Supplementary Note 7

The information processing method according to Supplementary Note 6, in which,
in the related line detection step, for each pair of the feature points, a virtual line passing through each feature point is specified by using the position and the angle information of each feature point constituting the pair, and the specified virtual lines of the feature points are detected as the pair of lines related between the images.

### Supplementary Note 8

The information processing method according to Supplementary Note 6, in which,
in the related region detection step, for each pair of the feature points, a virtual circle centered on each feature point is specified by using the position and the scale information of each feature point constituting the pair, and regions surrounded by the specified virtual circles of the feature points are detected as the pair of regions related between the images.

### Supplementary Note 9

The information processing method according to Supplementary Note 6, in which,
in the transformation matrix generation step, the generation of the homography matrix is executed a plurality of times while changing the pair of lines related between the images and the pair of regions related between the images, and one of a plurality of the generated homography matrices is selected.

### Supplementary Note 10

The information processing method according to Supplementary Note 6, in which,
in the transformation matrix generation step, a specific pair of the feature points and a pair of lines related between the images detected from the specific pair of feature points are selected, a vector connecting one feature point and the other feature point in the selected pair of feature points is calculated, a normal line formed by the calculated vector and the selected pair of lines is calculated, and whether to generate the homography matrix is determined based on a sign of a component of the calculated normal line.

### Supplementary Note 11

A computer-readable recording medium recording a program including a command for causing a computer to execute:
a related point detection step of extracting feature points having scale information and angle information from each of two images obtained by imaging the same object from different directions, and detecting a pair of the feature points related between the images from among the feature points extracted from the two images;
a related line detection step of detecting, for each pair of the feature points, a pair of lines related between the images by using a position and the angle information of each feature point constituting the pair;
a related region detection step of detecting, for each pair of the feature points, a pair of regions related between the images by using the position and the scale information of each feature point constituting the pair; and
a transformation matrix generation step of generating a homography matrix for transforming one of the images into the other by using the pair of lines related between the images and the pair of regions related between the images.

### Supplementary Note 12

The computer-readable recording medium according to Supplementary Note 11, in which,
in the related line detection step, for each pair of the feature points, a virtual line passing through each feature point is specified by using the position and the angle information of each feature point constituting the pair, and the specified virtual lines of the feature points are detected as the pair of lines related between the images.

### Supplementary Note 13

The computer-readable recording medium according to Supplementary Note 11, in which,
in the related region detection step, for each pair of the feature points, a virtual circle centered on each feature point is specified by using the position and the scale information of each feature point constituting the pair, and regions surrounded by the specified virtual circles of the feature points are detected as the pair of regions related between the images.

### Supplementary Note 14

The computer-readable recording medium according to Supplementary Note 11, in which,
in the transformation matrix generation step, the generation of the homography matrix is executed a plurality of times while changing a pair of lines related between the images and a pair of regions related between the images, and one of a plurality of the generated homography matrices is selected.

### Supplementary Note 15

The computer-readable recording medium according to Supplementary Note 11, in which,
in the transformation matrix generation step, a specific pair of the feature points and a pair of lines related between the images detected from the specific pair of feature points are selected, a vector connecting one feature point and the other feature point in the selected pair of feature points is calculated, a normal line formed by the calculated vector and the selected pair of lines is calculated, and whether to generate the homography matrix is determined based on a sign of a component of the calculated normal line.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

As described above, according to the present disclosure, it is possible to suppress instability of numerical operation in generation of a homography matrix using two related point pairs. The present disclosure is useful for a computer system in which image processing is required.

1. An information processing apparatus comprising:
at least one memory storing instructions; and
at least one processor configured to execute the instructions to:
extract feature points having scale information and angle information from each of two images obtained by imaging the same object from different directions, and detect a pair of the feature points related between the images from among the feature points extracted from the two images;
detect, for each pair of the feature points, a pair of lines related between the images by using a position and the angle information of each feature point constituting the pair;
detect, for each pair of the feature points, a pair of regions related between the images by using the position and the scale information of each feature point constituting the pair; and
generate a homography matrix for transforming one of the images into the other by using the pair of lines related between the images and the pair of regions related between the images.

2. The information processing apparatus according to claim 1, wherein
at least one processor specifies, for each pair of the feature points, a virtual line passing through each feature point by using the position and the angle information of each feature point constituting the pair, and detects the specified virtual lines of the feature points as the pair of lines related between the images.

3. The information processing apparatus according to claim 1, wherein
at least one processor specifies, for each pair of the feature points, a virtual circle centered on each feature point by using the position and the scale information of each feature point constituting the pair, and detects regions surrounded by the specified virtual circles of the feature points as the pair of regions related between the images.

4. The information processing apparatus according to claim 1, wherein
at least one processor executes the generation of the homography matrix a plurality of times while changing a pair of lines related between the images and a pair of regions related between the images, and selects one of a plurality of the generated homography matrices.

5. The information processing apparatus according to claim 1, wherein
at least one processor selects a specific pair of the feature points and a pair of lines related between the images detected from the specific pair of feature points, calculates a vector connecting one feature point and the other feature point in the selected pair of feature points, calculates a normal line formed by the calculated vector and the selected pair of lines, and determines whether to generate the homography matrix based on a sign of a component of the calculated normal line.

6. An information processing method comprising:
extracting feature points having scale information and angle information from each of two images obtained by imaging the same object from different directions, and detecting a pair of the feature points related between the images from among the feature points extracted from the two images;
detecting, for each pair of the feature points, a pair of lines related between the images by using a position and the angle information of each feature point constituting the pair;
detecting, for each pair of the feature points, a pair of regions related between the images by using the position and the scale information of each feature point constituting the pair; and
generating a homography matrix for transforming one of the images into the other by using the pair of lines related between the images and the pair of regions related between the images.

7. The information processing method according to claim 6, in which,
in the related line detection, for each pair of the feature points, a virtual line passing through each feature point is specified by using the position and the angle information of each feature point constituting the pair, and the specified virtual lines of the feature points are detected as the pair of lines related between the images.

8. The information processing method according to claim 6, in which,
in the related region detection, for each pair of the feature points, a virtual circle centered on each feature point is specified by using the position and the scale information of each feature point constituting the pair, and regions surrounded by the specified virtual circles of the feature points are detected as the pair of regions related between the images.

9. The information processing method according to claim 6, in which,
in the transformation matrix generation, the generation of the homography matrix is executed a plurality of times while changing the pair of lines related between the images and the pair of regions related between the images, and one of a plurality of the generated homography matrices is selected.

10. The information processing method according to claim 6, in which,
in the transformation matrix generation, a specific pair of the feature points and a pair of lines related between the images detected from the specific pair of feature points are selected, a vector connecting one feature point and the other feature point in the selected pair of feature points is calculated, a normal line formed by the calculated vector and the selected pair of lines is calculated, and whether to generate the homography matrix is determined based on a sign of a component of the calculated normal line.

11. A non-transitory computer-readable recording medium recording a program including a command for causing a computer to:
extract feature points having scale information and angle information from each of two images obtained by imaging the same object from different directions, and detect a pair of the feature points related between the images from among the feature points extracted from the two images;
detect, for each pair of the feature points, a pair of lines related between the images by using a position and the angle information of each feature point constituting the pair;
detect, for each pair of the feature points, a pair of regions related between the images by using the position and the scale information of each feature point constituting the pair; and
generate a homography matrix for transforming one of the images into the other by using the pair of lines related between the images and the pair of regions related between the images.

12. The non-transitory computer-readable recording medium according to claim 11, in which,
in the related line detection, for each pair of the feature points, a virtual line passing through each feature point is specified by using the position and the angle information of each feature point constituting the pair, and the specified virtual lines of the feature points are detected as the pair of lines related between the images.

13. The non-transitory computer-readable recording medium according to claim 11, in which,
in the related region detection, for each pair of the feature points, a virtual circle centered on each feature point is specified by using the position and the scale information of each feature point constituting the pair, and regions surrounded by the specified virtual circles of the feature points are detected as the pair of regions related between the images.

14. The non-transitory computer-readable recording medium according to claim 11, in which,
in the transformation matrix generation, the generation of the homography matrix is executed a plurality of times while changing a pair of lines related between the images and a pair of regions related between the images, and one of a plurality of the generated homography matrices is selected.

15. The non-transitory computer-readable recording medium according to claim 11, in which,
in the transformation matrix generation, a specific pair of the feature points and a pair of lines related between the images detected from the specific pair of feature points are selected, a vector connecting one feature point and the other feature point in the selected pair of feature points is calculated, a normal line formed by the calculated vector and the selected pair of lines is calculated, and whether to generate the homography matrix is determined based on a sign of a component of the calculated normal line.
While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.
